(19) United States
(12) Patent Application Publication
(10) Pub. No.: US 2005/0162362 A1
(43) Pub. Date: Jul. 28, 2005

(54) Image display apparatus and method of forming

(76) Inventors: Shinji Takasugi, Yokohama-shi (JP); Kazuyoshi Nagayama, Yamato-shi (JP); Mitsuri Ikezaki, Tokyo (JP)

Correspondence Address: TUNG & ASSOCIATES, 838 W. Long Lake Road, Suite 120, Bloomfield Hills, MI, 48302, US

(21) Appl. No.: 10/999,546

(22) Filed: Nov. 30, 2004

(30) Foreign Application Priority Data
Nov. 28, 2003 (JP) 2003-400090

(51) Int. Cl. G09G 3/36

(52) U.S. Cl. 345/90

(57) ABSTRACT

An image display apparatus and method that provides a flicker-proof thin-film-transistor liquid-crystal-display (TFT-LCD) is provided. The TFT-LCD has a first pixel circuit group having a plurality of first pixel circuits each having a first capacitance; a second pixel circuit group having a plurality of second pixel circuits each having a second capacitance; and a third pixel circuit group having a plurality of the first pixel circuits and the second pixel circuits arranged in accordance with a weighted average of m number of first pixel circuits and n number of second pixel circuits. The m and n first and second pixel circuits form an average third capacitance greater than the first capacitance of the plurality of first pixel circuits but less than the second capacitance of the plurality of second pixel circuits, wherein m and n are positive integers. The pixel circuit groups are formed on a matrix substrate.

### CROSS-REFERENCE TO RELATED APPLICATIONS

This is a cross-related Patent Application under 35 USC Section 119 (a) that claims a priority date of Nov. 28, 2003 from co-pending Japanese Application No. 2003-400090, filed on Nov. 28, 2003, the disclosure of which is incorporated by reference.

### TECHNICAL FIELD

The present invention relates in general to an image display apparatus that provides thin-film-transistor liquid-crystal-display (TFT-LCD). In particular, the present invention relates to a flicker-proof thin-film-transistor liquid-crystal-display and method of forming.

### BACKGROUND OF THE INVENTION

The structure of a conventional thin film transistor liquid crystal display (TFT-LCD) is comprised essentially of LCD cells comprising a pair of electrode substrates filled with liquid crystal molecules. Polarizers are adhered to the sides of the electrode substrates. Signal lines and scanning lines are formed perpendicularly with each other forming a matrix on one of the substrates. The scanning lines are connected to each gate of the TFT controlling the on/off state of the TFT and hence the writing of video signals.

FIG. 1 illustrates the circuit of a prior art image display apparatus or pixel circuit 20 in a conventional thin film transistor liquid crystal display (TFT-LCD). The pixel circuit 20 includes a switching component 22, wherein the switching component 22 is preferably a thin film transistor (TFT), a liquid crystal (LC) cell 24 and a storage capacitor C_{sc} 26.

The liquid crystal cell 24 includes a pixel electrode 30, a common electrode 32 and liquid crystal layer 34. When the TFT unit 22 is switched ON, a voltage V_{signal} of a signal line 36 is applied between the pixel electrode 30 and the common electrode 32 of the liquid crystal cell 24 for changing the orientation status of the liquid crystal molecules of liquid crystal layer 34. In such way, the transmittance of the liquid crystal cell 24 can be adjusted so as to change the illumination brightness of that pixel in response to the light emitted from a backlight source.

As shown in FIG. 1, the TFT component 22 is used as a switch component controlled by a voltage V_{scan} of scan line 28 to turn on or off. The thin film transistor has a gate electrode 44 electrically connected to the scan line 28, a drain electrode 42 electrically connected to the signal line 36, and a source electrode 42 electrically connected to a pixel electrode 30.

The storage capacitor C_{sc} 26 is electrically connected to the TFT component 22 and the pixel 24 is used to store voltage V_{signal} between the pixel electrode 30 and the common electrode 32 of the pixel 24. The storage capacitor is used to reduce the voltage variation of the liquid crystal cell due to current leakage and thus help the liquid crystal cell to store electric charges.

As shown in FIG. 1, the light passing through the pixels varies with the voltage applied to the liquid crystal cell 24. By changing the voltage to the liquid crystal cell 24, the amount of light passing through each pixel can be changed and thus the TFT-LCD can display predetermined images. The voltage applied to the liquid crystal cell is the difference between the voltage of the common electrode 32 and the voltage of the pixel electrode 30. When the thin film transistor 22 is turned off, the pixel electrode 30 is on a floating status. If any fluctuations occur in the voltages of electric elements around the pixel electrode 30, the fluctuations will cause the voltage of the pixel electrode 30 to deviate from its desirable voltage. The deviation of the voltage of the pixel electrode is referred to as a feed-through voltage V_{feedthrough} (ΔVₚᵢₓₑₗ), which is represented by:
V_{feedthrough}=ΔV_{G}*[C_{gs}/(C_{lc}+C_{sc}+C_{gs})]
where ΔV_{G} (or ΔV_{gate}) is the amplitude of a pulse voltage applied to the gate electrode 44 from the scan line 28, C_{lc} is the capacitance of the liquid crystal cell 24, C_{gs} is the capacitance between the gate electrode 44 and the source electrode 40, and C_{sc} is the capacitance of the storage capacitor formed between a scan line 46 and the pixel electrode 30.

Thus, a change in the gate voltage ΔV_{gate} results in a change in the voltage feedthrough V_{feedthrough} to the pixel electrode 30. The variance in the voltage at the pixel electrode 30, ΔVₚᵢₓₑₗ is different for each pixel that is equipped with a pixel electrode 30, depending on the capacitance of the TFT and the distance of the TFT from the scan line 28 driving circuit (not shown). The voltage at the pixel electrode 30 changes with a corresponding change in the display brightness which leads to non-uniform brightness.

Because of the resistors and capacitors inherent on the scanning line, a pulse voltage input signal input at a front end (not shown) of the signal scan line 28 that is applied to each gate electrode of TFT in a TFT pixel matrix is subjected to an RC (time constant) delay. At the end of the scan line 28, the pulse voltage input signal applied to the gate electrode 44 is transformed to an attenuated and distorted waveform that having a rounded falling edge.

The feed-through voltage V_{feedthrough} of a pixel decreases as the distance between a scan line drive circuit (not shown) and the pixel increases. Thus, V_{feedthrough} gradually becomes smaller as the distance of the pixel unit from the scan line input end increases because of increases in the RC delay.

For example, a feed-through voltage V_{feedthrough1} of a pixel A closest to a front end of a scan line is larger than that of a feed-through voltage V_{feedthrough2} of a pixel B located farther from the front end of the scan line than pixel A.

This decrease in V_{feedthrough2} causes an image displayed on the display apparatus to flicker. It is difficult to achieve a uniform V_{feedthrough} of a TFT that can accurately respond to a continuous change in the voltage amplitude V_{scan}.

A border region in-between the pixel circuits that has different parasitic capacitances can make the brightness of the display non-uniform if the parasitic capacitance Cgs is not continuously changed when transitioning between neighboring pixels located along a scan line.

The Cgs is formed by an overlapping region between the source and the gate region, and can be adjusted by varying the size or area of the overlapping region. It is desirable to continuously and gradually adjust the overlap of the gate electrode and source electrode of each pixel circuit to compensate for RC delays causing non-uniform V_{feedthrough}. The desirable overlapping width is changed in a range between 0.25 μm˜0.5 μm.

Fabrication techniques including lithography must be matched to a design specification such as a specified mask resolution to form a TFT switching component 22 having a desired Cgs that is based on a known RC delay and the ΔV_{G}.

However, due to present processing constraints, the size of the overlapping region between the source and the gate region is limited to about 0.9 μm.

Because of these limitations, It is difficult to manufacture a TFT having pre-determined Cgs capacitances that can compensate for pulse voltage input Vscan voltage changes and V_{feedthrough} changes for each pixel in a pixel matrix located on a TFT matrix display. Continuous adjustment of the Cgs by changing the structure of each TFT within each pixel to increase the overlapping region beyond a width range of 0.25 to 0.5 μm is not feasible. Thus, it is not possible to rely on the design and process definition of a TFT to enable a constant V_{feedthrough} of each of a plurality pixel circuits located at varying distances from the scan line driver circuit.

Moreover, the problem of parasitic capacitance produced in each pixel circuit exists beyond the scanning lines. Parasitic capacitances may also exist in-between the signal lines and outside of the scanning lines, thus, parasitic capacitances from neighboring pixel units or circuits may also affect the voltage V_{feedthrough} of each pixel electrode 30 in each neighboring pixel circuit.

Accordingly, it is difficult to compensate feed-through voltages for all pixels by adjusting the voltage of the common counter electrode. Therefore, it is hard to provide a TFT-LCD without a flicker.

It is desirable to provide a feedthrough voltage V_{feedthrough1} that is approximately equal to V_{feedthrough2} to avoid the flicker phenomenon when transitioning between a border region of pixel circuit A and a pixel circuit B.

### SUMMARY OF THE INVENTION

The present invention resolves the above problems and thus is able to provide an image display apparatus capable of suppressing a voltage change that exists at a pixel electrode, ΔVₚᵢₓₑₗ, in a pixel circuit due to voltage signals transmitted from a switching component in the pixel circuit as well as from neighboring pixel circuits.

The present invention operates to suppress a non-uniform brightness in the displayed image in transitional border regions in-between the pixel circuits that have different parasitic capacitances as well as reducing the flicker phenomenon present in conventional pixel displays.

Also, the present invention operates to adjust a capacitance Cgs for a group of pixel circuits by setting a feedthrough voltage V_{feedthrough1} of an pulse voltage input signal approximately equal to the feedthrough voltage V_{feedthrough2} of the pulse voltage input signal transmitted to the end of a scan line.

Additionally, the present invention provides a feedthrough voltage V_{feedthrough1} that is approximately equal to V_{feedthrough2} to avoid the flicker phenomenon and to compensate for non-uniform borders in-between pixel circuits.

In a preferred embodiment, the image display apparatus of the present invention provides a first pixel circuit group having a plurality of first pixel circuits each having a first capacitance; a second pixel circuit group having a plurality of second pixel circuits each having a second capacitance; and a third pixel circuit group having a plurality of both the first pixel circuits and the second pixel circuits arranged in accordance with a weighted average of m number of first pixel circuits and n number of second pixel circuits. The m and n first and second pixel circuits form an average third capacitance that is greater than the first capacitance of each of the plurality of first pixel circuits but is less than the second capacitance of each of the plurality of second pixel circuits, wherein m and n are positive integers.

Each of the first and second pixel circuits are formed by an associated pixel electrode for receiving a voltage corresponding to a display brightness and a signal line for transmitting a voltage signal. Additionally, each of the pixel circuits have a switching component having a drain electrode, a source electrode and a gate electrode, wherein the switching component is preferably an n-channel thin film transistor that is switched on and off in accordance with a scan line voltage signal.

The pixel circuit groups are formed on a TFT matrix substrate. An opposing substrate is positioned opposite to the TFT matrix substrate. Additionally, a liquid crystal layer is sealed in-between the TFT matrix substrate and the opposing substrate. Preferably alignment films are used to orient molecules disposed within the liquid crystal layer. Optionally, at least one color filter may be disposed on at least one of an inside surface of the opposing substrate or on an outside surface of the TFT matrix substrate to display a color image.

### BRIEF DESCRIPTION OF THE DRAWINGS

Embodiments of the present invention will become more fully understood from the detailed description and the accompanying drawings, wherein:

FIG. 1 illustrates the circuit of a prior art image display apparatus.

FIG. 2 shows a perspective, analytical view of a complete structure of an image display apparatus in accordance with a preferred embodiment of the present invention.

FIG. 3 shows the circuit structure of each pixel circuit.

FIG. 4 is a cross-sectional view of a TFT switching component used in accordance with the image display apparatus of the present invention.

FIG. 5 illustrates a parabolic shaped graph representing a relationship between a pixel circuit having a pixel electrode that is located from a predetermined distance from a scan driver circuit and a corresponding capacitance Cgs.

FIG. 6 illustrates an enlarged view of a portion of the graph shown in FIG. 5.

FIG. 7 provides three TFT pixel groups having varying capacitances that have a capacitance Cgs in accordance with a preferred embodiment of the present invention.

FIG. 8 provides three TFT pixel groups having varying capacitances that have a capacitance Cgs in accordance with a preferred embodiment of the present invention.

FIG. 9 illustrates an enlarged view of a portion of the graph shown in FIG. 5.

FIG. 10 illustrates a structure that has a first circuit pixel group, a second circuit pixel group and four third circuit pixel groups disposed between the first pixel circuit group and the second pixel circuit group 102 in accordance with a preferred embodiment of the present invention.

FIG. 11 shows an image display apparatus which has a structure for displaying color images by using adjacent R (red), G (green), and B (blue) sub-pixels in three different pixel circuit groups.

FIG. 12A shows an image display apparatus which has a structure for displaying color images by using adjacent R (red), G (green), and B (blue) sub-pixels in a first pixel circuit group, a second pixel circuit group and two third pixel circuit groups in accordance with a preferred embodiment of the present invention.

FIG. 12B shows an image display apparatus which has a structure for displaying color images by using adjacent R (red), G (green), and B (blue) sub-pixels in a first pixel circuit group, a second pixel circuit group and two third pixel circuit groups in accordance with a preferred embodiment of the present invention.

FIG. 13 provides three TFT pixel groups having varying capacitances that have a capacitance Cgs in accordance with a preferred embodiment of the present invention.

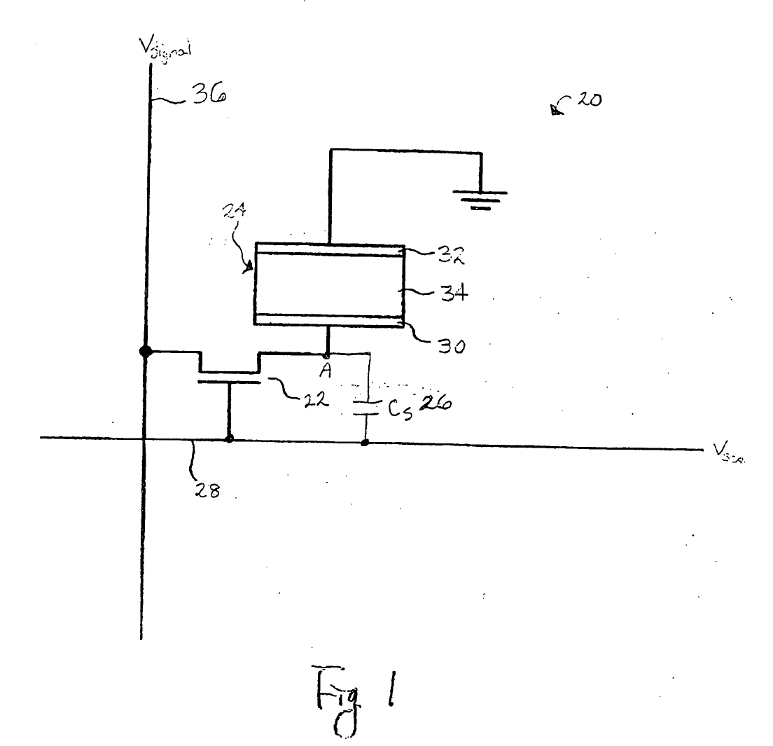

### DETAILED DESCRIPTION OF THE PREFERRED EMBODIMENTS

Exemplary embodiments of an image display device and a liquid crystal display apparatus according to the present invention are explained below with reference to the drawings. In the following embodiments, when there is a plurality of parts of the same configuration, one of these parts is explained as a representative when necessary.

When the same part is explained using a plurality of drawings, a reference symbol shown in one drawing will also be used in the rest of the drawings. Identification characters a, b, c, etc. are assigned to reference symbols when necessary. When there are a plurality of the same parts like “scan line driver 72a, and 72b”, these parts are collectively called a “scan line driver 72” when necessary.

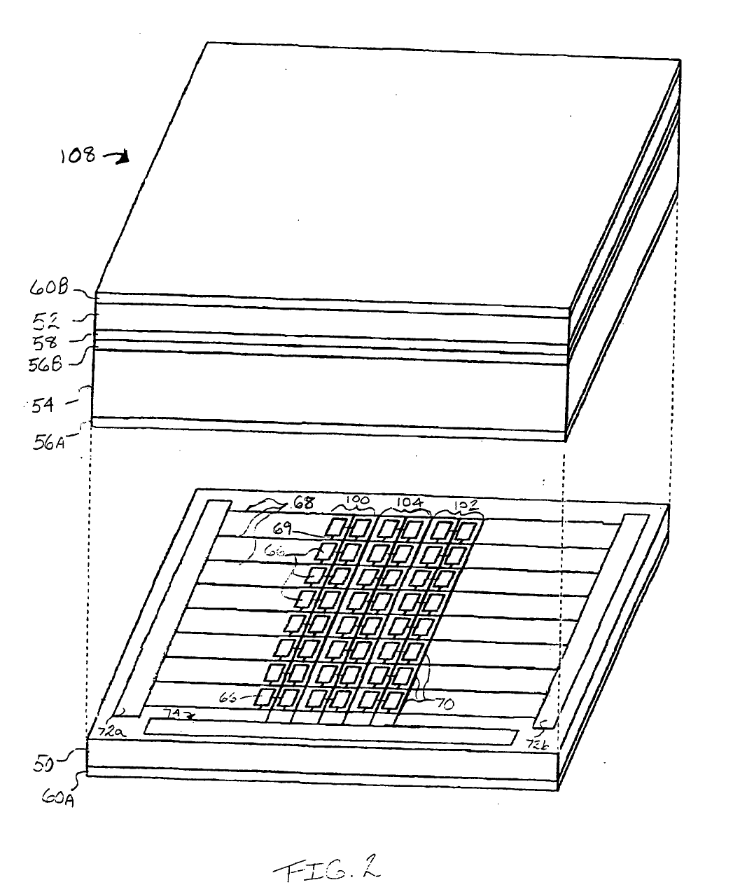

FIG. 2 shows a perspective, analytical view of a complete structure of an image display apparatus in a preferred embodiment of the present invention. The image display apparatus is constructed by a configuration having a plurality TFT-LCD display pixel circuits arranged in a TFT-LCD matrix on a TFT matrix substrate. More particularly, the image display apparatus 108 has a TFT matrix substrate 50, an opposing substrate 52 which is positioned opposite to the TFT matrix substrate 50, and a liquid crystal layer 54 which is sealed in-between the TFT matrix substrate 50 and the opposing substrate 52. An alignment film 56A is adhered to a top surface of the matrix substrate 50, while an alignment film 56B is adhered to a bottom surface of a common electrode 58 are formed on an underside of the opposing substrate 52. The alignment films 56A and 56B directly contact the liquid crystal layer 54. On an outside surface of the TFT matrix substrate 50 and the opposing substrate 52, is further provided with polarizing plates 60A, 60B.

The matrix substrate 50 and the opposing substrate 52 may have a structure formed with a transparent plastic substrate and quartz glass or the like according to the usage. The substrates 50, 52 have flat and smooth surface characteristics, wherein the flat and smooth surface characteristics provide an excellent shape to avoid giving influence to the course of a light that is incident from beneath, and have a low coefficient of thermal expansion.

A common electrode 58 is further provided on an inside surface of the opposing substrate 52 which is used to produce a desirable electrical field in conjunction with a pixel electrode 64 of a pixel circuit 66. The common electrode 58 and the pixel electrode 64 are preferably formed with indium tin oxide (ITO), indium zinc oxide (IZO) or the like having conductivity and excellent light transmission characteristics respectively.

Color filters corresponding to red, green and blue may optionally be added to the image display apparatus of the present invention to provide color images on the image display apparatus. A color filter (not shown) may be disposed on an inside surface of the opposing substrate 52 or on the outside surface of the matrix substrate 50 to make it possible to display a color image. The color filter transmits wavelengths corresponding to R (red), G (green), and B (blue) out of an incandescent light that is transmitted through the liquid crystal layer 54, thereby to achieve a color image display. Light transmission characteristics such as transflective electrodes may also be optionally provided on the inside surface of posing substrate 52.

The liquid crystal layer 54 is formed to have a plurality of liquid crystal molecules having orientation as a main component. A fluorinated pneumatic liquid crystal molecule can be used as an example of the liquid crystal that constitutes the liquid crystal layer 54. There is no particular limitation to the liquid crystal molecule, and thus, any other suitable liquid crystal materials may also be used in the present invention image display apparatus.

In order to prescribe the orientation of the liquid crystal molecule included in the liquid crystal molecule layer 54, both or either one of the matrix substrate 50 and the opposing substrate 52 generally has a configuration of an alignment film provided on the surface in contact with the liquid crystal layer 54. The alignment films 56A and 56B are used to determine the initial orientation of liquid crystal molecules, and thus polarize the molecules disposed within the liquid crystal layer 54.

The polarizer plates 60A and 60B allow the passing of certain components of light from an input light beam. The polarizing plates 60A and 60B polarize the light that passes through. Normally, the upper plate 60A and the lower polarizing plate 60B each have a polarizing direction that is 90 deg. apart so that incident light polarized from the lower plate 60B cannot go through to the upper polarizing plate 60A. The polarized incident light then goes through the LC layer and is polarized in the direction of the incident light by 90 degrees so that it can pass through the upper polarizer plate 60A. Thus, the LC layer operates as a light gate and by changing the direction of the LC molecules, the degree of polarization of the light is controlled.

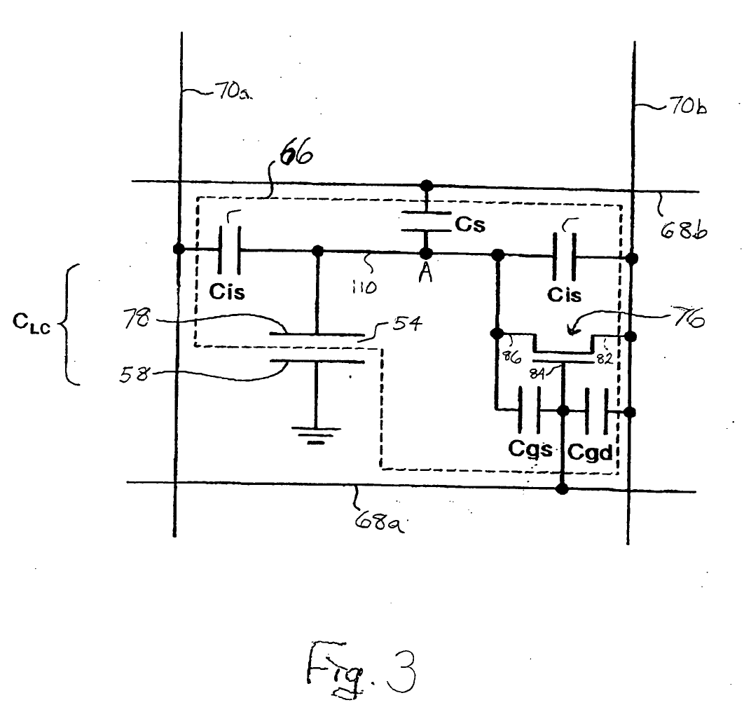

A back light source not shown that functions as a light source is provided beneath the matrix substrate 50, and irradiates a plane beam of an incandescent light to the matrix substrate 50. The liquid crystal layer 54 has a function of generating lights and shades on the screen by controlling a light transmittance of the irradiated incandescent light corresponding to the potential of the pixel electrode 78 (shown in FIG. 3), thereby to display the image. Specifically, a predetermined potential is given to the pixel electrode 78 to generate an electric field between the pixel electrode 78 and the common electrode 58. The orientation of the liquid crystal molecules within the liquid crystal layer 54 is controlled in the electric field. The light transmittance is controlled following the change in the orientation.

FIG. 2 illustrates a circuit structure that is formed on the matrix substrate 50. As shown in FIG. 2, a plurality of pixel circuits 66 are formed in a matrix form with a plurality of parallel scan lines 68, which are arranged in a plurality of rows that operate to electrically connect each one of the plurality pixel circuits 66 in each row to another pixel circuit 66 in the same row; and with a plurality of parallel signal lines 70, which are arranged in columns that are perpendicular to the scan lines 68, wherein the signal lines 70 operate to electrically connect all pixel circuits 66 in a same column with each other. Thus, each of the pixel circuits 66, are bounded by two adjacent scan lines and two adjacent signal lines; and a plurality of thin film transistors 76 formed at intersections between the scan lines 68 and signal lines 70.

Furthermore, two scanning driver circuits 72a, 72b that operate to connect to and to drive the scan lines 68 are provided on the matrix substrate 50. The scan driver circuit 72a is positioned on the left end of a top surface of the TFT matrix substrate 50, as shown in FIG. 2 and scan driver circuit 72b is positioned on the right end of the TFT matrix substrate 50, wherein the two scan driver circuits 72a, 72b cooperate to form a double-side drive.

The scan driver circuits 72a, 72b transmit a scanning signal to each pixel circuit 66 through the scan lines 68. The scan signals are voltage signals which have a sufficient amplitude Vscan (ΔVgate) to turn on each switching component thin film transistor 22 in each pixel circuit 66. The voltage signal is transmitted in one preferred embodiment, by scan line 68, and then by a connecting line 69 disposed between each pixel circuit 66. The scan signal waveform of the Vscan voltage signal gradually loses its shape and becomes attenuated as the distance from the scan line driver circuits 72a or 72b increases as well as the RC delay increases.

The signal driver circuit 74 sends a display signal to each of the pixel circuits 66 through each of the signal lines 70. The signal driver circuit 74 operates to produce a voltage signal Vsignal corresponding to the display brightness of each pixel circuit 66.

FIG. 3 illustrates the structure of each pixel circuit 66, and also illustrates the relationship between each pixel circuit 66 and the peripheral wires surrounding each pixel circuit 66. As shown in FIG. 3, the structure of a pixel circuit 66 has a switching component 76, and a pixel electrode 78 which receives a voltage signal corresponds to the display brightness desired.

Moreover, adjacent to the pixel circuit 66, are scan lines 68a, signal lines 70a, 70b, and a capacitance line 68b which maintains a fixed voltage to the pixel electrode 78. A source electrode 86 of the thin-film transistor 76 is connected to the pixel electrode 78. A drain electrode 82 is connected to the signal line 70b. A gate electrode 84 of the thin-film transistor 76 is connected to the scan line 68a. The ON and OFF of the thin-film transistor 76 is controlled by a scan signal supplied from the scan line 68a. A predetermined charge is accumulated in the storage capacitor Cs to help maintain a constant voltage at the pixel electrode 78. In the first embodiment, an n-channel thin-film transistor is explained as the thin-film transistor 76. Alternatively, the present invention can also be applied to a p-channel thin-film transistor.

The TFT 76 has a drain electrode 82 that is electrically connected to the signal line 70b, a gate electrode 84 that is electrically connected to the scan line 68, and a source electrode 86 at is electrically connected to the pixel electrode 78. The switching component 76 operates to control a state of conductance or non-conductance between the signal line 70b and the pixel electrode 78 based on a value of the gate electrode voltage Vg for the scan driver circuit 72a, 72b. When the gate-source voltage Vgs measured at the gate electrode 84 and the source electrode 86 is higher than the ON voltage of the thin film transistor, the signal line 70b and the pixel electrode 78 are electrically connected together. When the voltage value at the gate electrode 84 and the source electrode 86 is lower than the ON voltage, the signal line 70b and the pixel electrode 78 are disconnected.

The pixel electrode 78 which is positioned opposite to the common electrode 58 formed on the interior surface of the opposing substrate 52, is formed on the matrix substrate 50 and an electrostatic capacitance C_{LC} is formed in-between the common electrode 58 and the pixel electrode 78 in the liquid crystal layer 54. Moreover, a voltage that corresponds to the display brightness is applied to the pixel electrode 78 through signal line 70a. Simultaneously, the voltage at the common electrode 58 is maintained at a constant value. An electrical field that corresponds to the display brightness is then applied to the liquid crystal layer 54 that is sealed in-between the pixel electrode 78 and the common electrode 58. The electrical field affects the liquid crystal molecules contained in the liquid crystal layer 54 to change the direction of the molecules as desired. The display brightness of an image displayed on the image display apparatus changes in accordance with the transmission rate of voltage through the liquid crystal layer 54.

The capacitance line 68a is used to reduce a variation voltage at the pixel electrode 78. As disclosed herein, the voltage of the pixel electrode 78 varies in accordance with the voltage scan signal Vscan transmitted by the scan line 68a. The capacitance line 68b maintains a constant or fixed voltage to help suppress variations in voltages Vscan transmitted by the scan line 68a by placing a capacitor Cs in-between the pixel electrode 78 and the capacitance line 68b to assist in suppressing voltage variations in Vscan signals sent along the scan lines 68. The capacitance line is perpendicular to the signal lines 70a, 70b and is parallel to the scan line 68a.

Electrostatic capacitance Cs is produced in-between the various connection lines due to the proximate location of each of the connection lines and the components within the pixel circuit 66, wherein the connection lines include scan line 68a, capacitance line 68b, and signal lines 70a, 70b.

An electrostatic capacitance Cgs is produced in-between the gate electrode 84 and the source electrode 86 of the switching component 76; an electrostatic capacitance Cgd is produced between the gate electrode 84 and the drain electrode 82 of the switching component 76; and an electrostatic capacitance Cis representing a parasitic capacitance from connecting lines is produced between the pixel electrode 78 and the signal lines 70a, 70b. As shown in FIG. 3, an electrostatic capacitor Cgs is produced in-between the gate electrode and the source electrode of the switching component 76. However, since the gate electrode 84 of the switching component 76 is electrically connected to the scan line 68 and the source electrode 86 is electrically connected to the pixel electrode 78, the electrostatic capacitor Cgs can therefore be viewed as an equivalent electrostatic capacitor produced in-between the scan line 68 and the pixel electrode 78.

A method is described in the following section to adjust the capacitance of the electrostatic capacitor Cgs formed within the TFT 76 to compensate for voltage variations at the pixel electrode 78 (ΔVₚᵢₓₑₗ) that are produced based on the waveform variation of the voltage signal transmitted by the scan line 68.

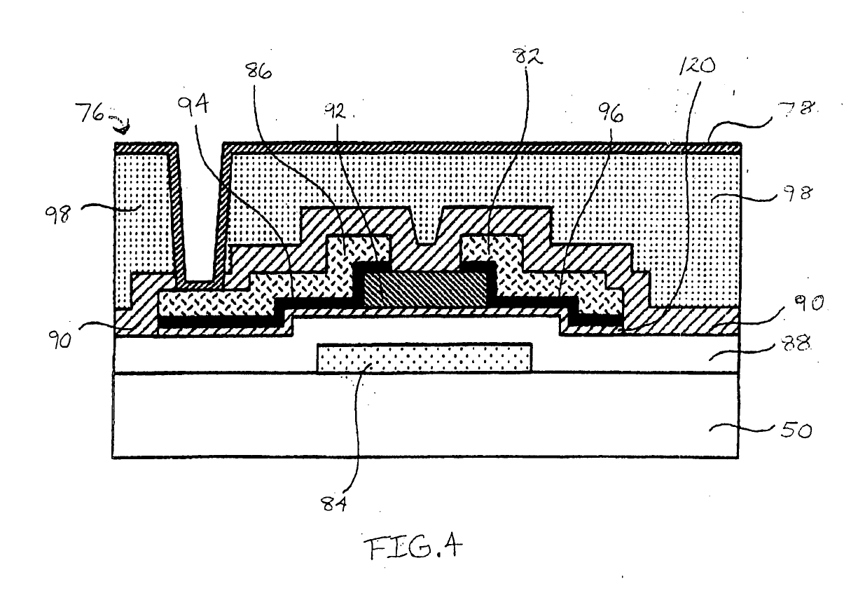

FIG. 4 is a cross-sectional view of the switching component 76, wherein the switching component 76 is a thin film transistor. The thin film transistor 76 has a gate electrode 84 which is formed by deposition in a partial area on the matrix substrate 50; a gate insulator layer 88 which is deposited in the other areas of the matrix substrate 50 and on top of the gate electrode 84 and which is preferably formed with a transparent and insulating material such as SiO₂ or SiNₓ; an electrical conductive layer 120 for forming wiring lines is deposited on a respective partial area of the gate electrode insulating layer 88; an etch stop layer 92 deposited on a partial area of the electrical conductive layer 120; a source region 94 and a drain region 96 which are formed on a partial area of the electrical conductive layer 90 and the etch stop layer 92, which is also doped with a high concentration of dopant. Additionally, the source electrode 86 is deposited on the source region 94, the drain electrode 82 is deposited on the drain region 96 such that the above-cited components can be used to form the thin film transistor 76.

As shown in FIG. 4, a top surface of the thin film transistor is covered by the protective layer 90 such that it is protected and isolated from the atmosphere. A planarization layer 98 forms a top planarized surface on top of the protective layer 90. Also, the pixel electrode 78 is formed on top of the planarization layer 98. The pixel electrode 78 penetrates through both a partial area of the planarization layer 98 and the protective layer 90 in order to electrically connect with the source electrode 86 of the TFT 76.

Also shown in FIG. 4, the gate insulating layer 88, the electrical conductive layer 120 and the etch stop layer 92 are disposed in-between the gate electrode 84 and the source electrode 86 of the TFT 76. The thickness of the gate insulating layer 88 is very small due to the processing constraints of thin film transistors.

The electrostatic capacitor Cgs formed in-between the gate electrode 84 and the source electrode 86 has a magnitude of capacitance that is related to a horizontal cross-section of the etch stop layer 92. It is possible to adjust the shape or area of the etch stop layer 92 to make the capacitance of the electrostatic capacitor Cgs equivalent to a desired capacitance that can effectively suppress variations in voltages V_{feedthrough}. Thus, the structure of the switching component 76 may be adjusted in order to suppress the voltage variations that exist at the pixel electrode 78 when a varying pulse voltage input signal Vscan (ΔV_{g}) is transmitted through the scan line 68.

An average capacitance Cgs_{avg} effective to suppress variations in voltages V_{feedthrough} can be created by creating a pixel circuit group formed from a plurality of pixel circuits using TFTs having varying known capacitances, C1 and C2 between the gate electrode and the source electrode Cgs.

In the present invention, as shown in FIGS. 2-3, the scan line 68 for transmitting a pulse voltage input signal Vscan is illustrated as a straight line in the horizontal direction. The scan driver circuit 72a; 72b produces a wave form that loses it shape or becomes distorted due to resistances and capacitances (RC delay) inherent in the scan lines that are present during the transmission process of transmitting a voltage signal from the scan driver circuit 72a, 72b through the scan lines 68 to each pixel circuit 66. A desired capacitance Cgs effective to eliminate voltage variations at the pixel electrode 78 (ΔVₚᵢₓₑₗ) can be calculated by using a predetermined distance from either the scan driver circuit 72a or the scan driver circuit 72b to each pixel circuit 66.

As shown in FIGS. 2, 7, 8, 10 and 13, the present invention provides TFT pixel groups having varying capacitances that have a capacitance Cgs between a gate electrode and a source electrode that can range between at least two predetermined Cgs capacitances C1 and C2 for TFT's arranged in the matrix between a first pixel group and a second pixel group. As disclosed herein, it is possible to achieve the capacitances of C1 and C2 by manufacturing TFTs in accordance with the device and method disclosed in FIGS. 2-4.

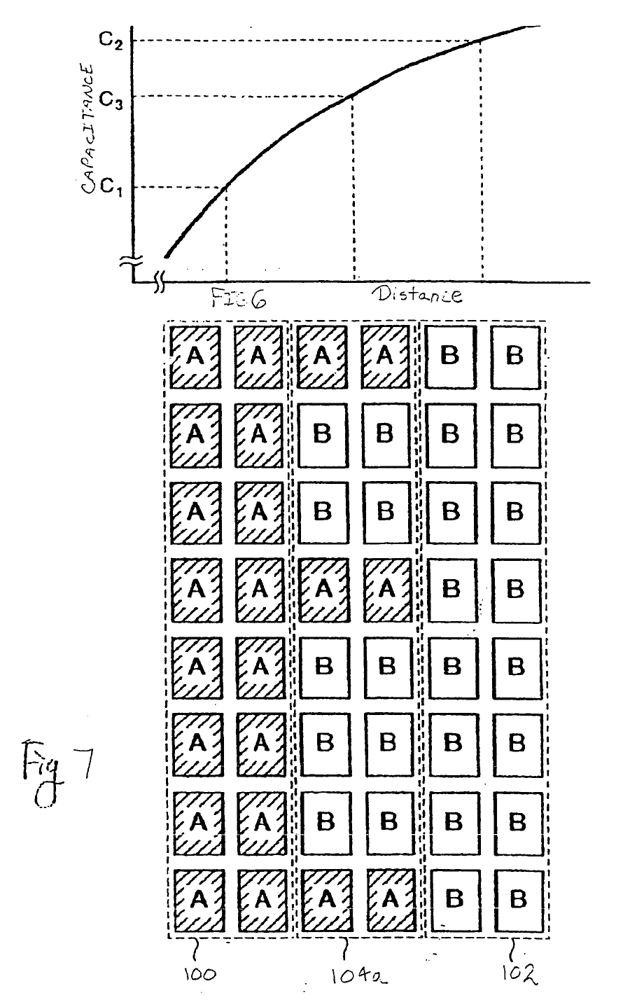

Additionally, a pre-requisite for a desired capacitance illustrated in FIG. 6 as C3 is that the electrostatic capacitor Cgs that has a capacitance C3 that is greater than C1 but less than C2. Due to processing restraints of TFT's, it is difficult to form a single pixel circuit that has an internal capacitance equal to C3, wherein the pixel circuit having an internal capacitance equal to C3 is located in a position between a front end of a scan line closest to a scan line driver circuit and a rear end of a scan line farthest from a scan line driver circuit.

Thus, in accordance with a preferred embodiment of the present invention, at least two TFT pixel circuits 66 each having an associated Cgs that compensates for various voltage waveform in the scan line causing a non-uniform V_{feedthrough} at a predetermined location in the pixel matrix are provided. Thus, the pixel circuits 66 can be arranged such that a first pixel group 100 having a plurality of pixel circuits A that have a capacitor Cgs that has an associated capacitance C1, wherein the first pixel group 100 is arranged in a predefined number of rows and columns near a front end of a scan line, i.e., closer to the front end of the scan line 68a. Additionally, a second pixel group 102 having a plurality of pixel circuits B that have a capacitor Cgs that has an associated capacitance C2, wherein the second pixel group 102 is arranged in a predefined number of rows and columns near a rear end of a scan line, i.e., farther from the front end of the scan line driver 72a than the first pixel group 100 is located from the scan line driver 72a.

FIG. 7 illustrates a portion or local area of the TFT matrix, wherein group 100 is closer to the front end of the scan line, and group 102 is farther from the front end of the scan line.

A first pixel circuit group 100 is formed by a plurality of pixel circuits A each having a corresponding electrostatic capacitor Cgs equal to C1. The average capacitance of the first pixel circuit group is the summation of the individual capacitances of each pixel circuit A in the first pixel group divided by the total number of pixels m in the first pixel circuit group 100.

Similarly a second pixel circuit group 102 is formed by a plurality of pixel circuits B each having a corresponding electrostatic capacitor Cgs equal to C2. The average capacitance of the second pixel circuit group is the summation of the individual capacitances of each pixel circuit B in the second pixel group divided by the total number of pixels n in the second pixel circuit group 102.

At least one additional, third pixel group 104 is formed by mixing a plurality of pixel circuits A with a plurality of pixel circuits B in accordance with a weighted ratio of pixel circuits A to pixel circuits B. A desired capacitance Cx, representing a weighted average capacitance Cgs for the at least one third pixel group 104 is then achieved by distributing the capacitances C1 and C2 throughout the third pixel group Cx.

In addition, the pixel circuit A and the pixel circuit B in the at least one third pixel circuit group 104 are mixed together at a ratio such that the capacitance of the third pixel circuit group 104 is calculated using a weighting factor adjusted mean of all circuits similar to that of Cx. A weighted average capacitance Cx can be determined in accordance with the following equation:
Cx=(mC1+nC2)/(m+n)
wherein m represents the number of pixel circuits A in the third pixel group, wherein n represents the number of pixel circuits B in the third pixel groups, and wherein x is an integer greater than 2.

Thus, the pixel circuits A and B having capacitances C1 and C2, respectively are distributed to form the desired capacitance Cx, i.e. are arranged such that a ratio between the number of pixel circuit A's to the total number of pixels is mC1/(m+n) and the a ratio between the number of pixel circuit B's to the total number of pixels is nC2/(m+n). The weighting factor used to distribute pixel circuits A and B to form the third pixel circuit group 104 provides for a mean capacitance Cgs to be determined for the entire pixel circuit group 104, wherein the mean capacitance Cgs is equal to Cx.

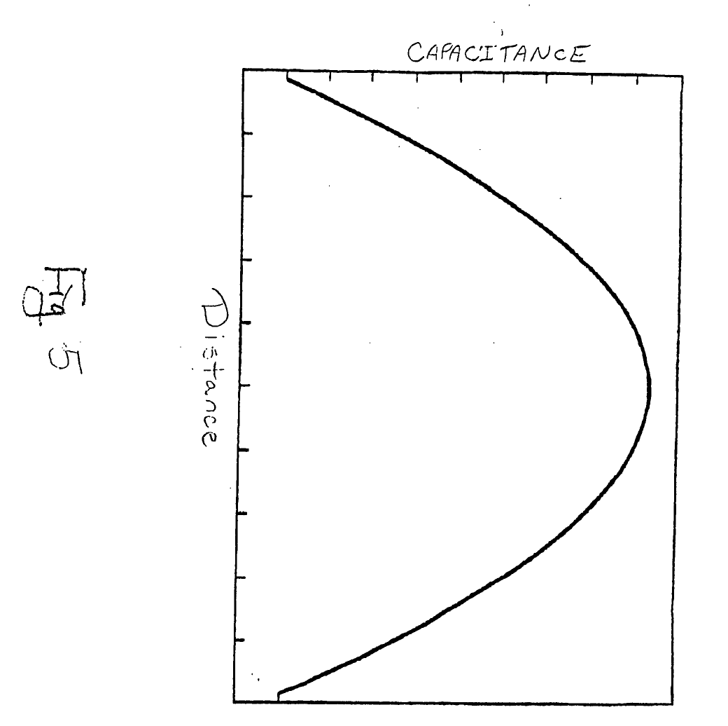

As shown in FIG. 5, that illustrates a parabolic shaped graph representing a relationship between a pixel circuit having a pixel electrode that is located at a predetermined distance from a scan driver circuit and a corresponding capacitance Cgs associated with the pixel circuit necessary to eliminate a voltage variation of the pixel electrode associated with the pixel circuit. As shown in FIG. 5, the Y-axis corresponds to various Cgs capacitance values, and the X-axis corresponds to a distance of each pixel associated with a corresponding capacitance Cgs from a scan driver circuit.

FIG. 6 illustrates an enlarged view of a portion of the graph shown in FIG. 5. The graph as shown in FIG. 6, corresponds to the capacitances of first, second, and third pixel groups 100, 102, and 104a, respectively of FIG. 7.

In a preferred embodiment shown in FIGS. 7 and 13, the first pixel circuit group 100 has 16 pixel circuit A's arranged in 8 rows and 2 columns. Similarly, the second pixel circuit group 102 has 16 pixel circuit B's arranged in 8 rows and 2 columns. The third pixel groups 104a, 104h arranges pixel circuits A and B into 8 rows and 2 columns, wherein each of the 8 rows has pairs of same pixel circuits, A and B respectively, arranged in a ratio of 6 pixel circuit A's to 16 total pixels and 10 pixel circuit B's to 16 pixels for third pixel group 104h, and arranged in a ratio of 8 pixel circuit A's to 16 total pixels and 8 pixel circuit B's to 16 pixels for third pixel group 104h. Because the capacitance C1 and C2 are constant values, the capacitance of Cx, wherein x equals 3 for third pixel group 104a can be determined as follows:
C3=(6*C1+10*C2)/16.

The repeating pattern of A to B pixel circuits within the third pixel group 104a is a square matrix pattern formed by a 1:2:1:3:1 ratio of pixel circuit A, pixel circuit B, pixel circuit A, pixel circuit B, and pixel circuit B.

Similarly, C3 is determined as follows for the third pixel group 104h shown in FIG. 13:
C3=(8*C1+8*C2)/16=½(C+C2).

As shown in FIG. 13, the repeating pattern of A to B pixel circuits within the third pixel group 104h is a square matrix pattern formed by a 1:1:2 ratio of pixel circuit A, pixel circuit B, and pixel circuit A and then a ratio of 1:1:2 of pixel circuit B, pixel circuit A, pixel circuit B.

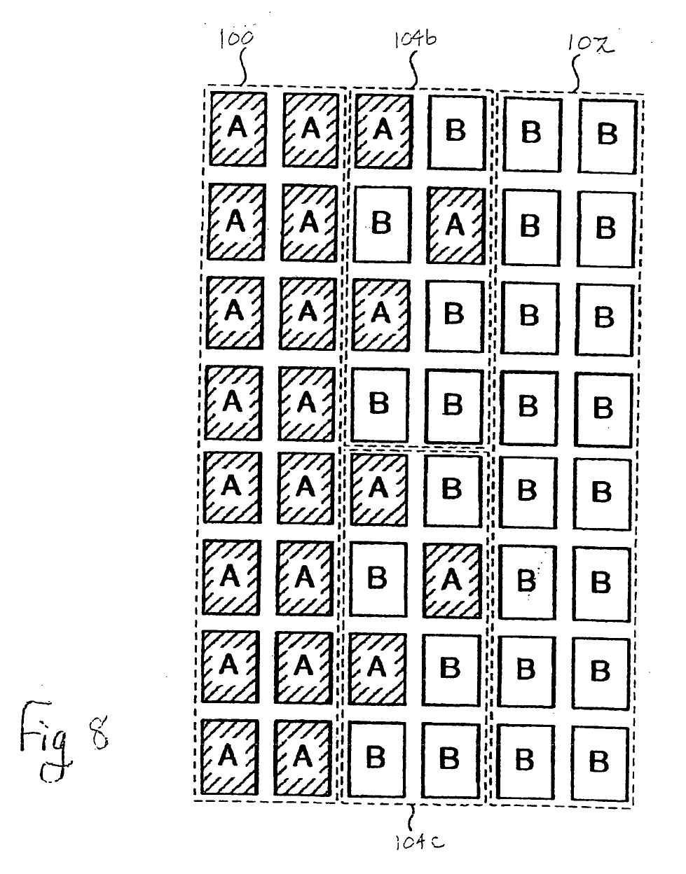

Similar calculations for Cx can be determined for the third pixel groups 104b and 104c in FIG. 8, wherein two third pixel groups, 104b and 104c are each arranged in a four row, two column pattern of a mixture of pixel circuits A and B, and wherein Cx is equal to C3 for third pixel group 104c, and wherein Cx is equal to C4 for third pixel group 104c.

The method of the present invention reduces the number of pixel circuits A and B used to produce an average third capacitance that is equal to or substantially close to a target capacitance C3. Accordingly, the reduced number of mixed pixel circuits A and B forming the third pixel group having an average capacitance Cx to a minimum number of pixel circuits arranged in a repeating pattern within the third pixel group. For example, by reducing the number of mixed pixel circuits A and B that are weighted in each of the third pixel circuit groups 104b and 104c, a narrower range of capacitance values may be adjusted by a weighting factor adjusted mean of the capacitance Cgs to allow for more accurate suppression of V_{feedthrough} voltages of the mixed pixel circuits A and B arranged in a repeating pattern that form the third pixel circuit group.

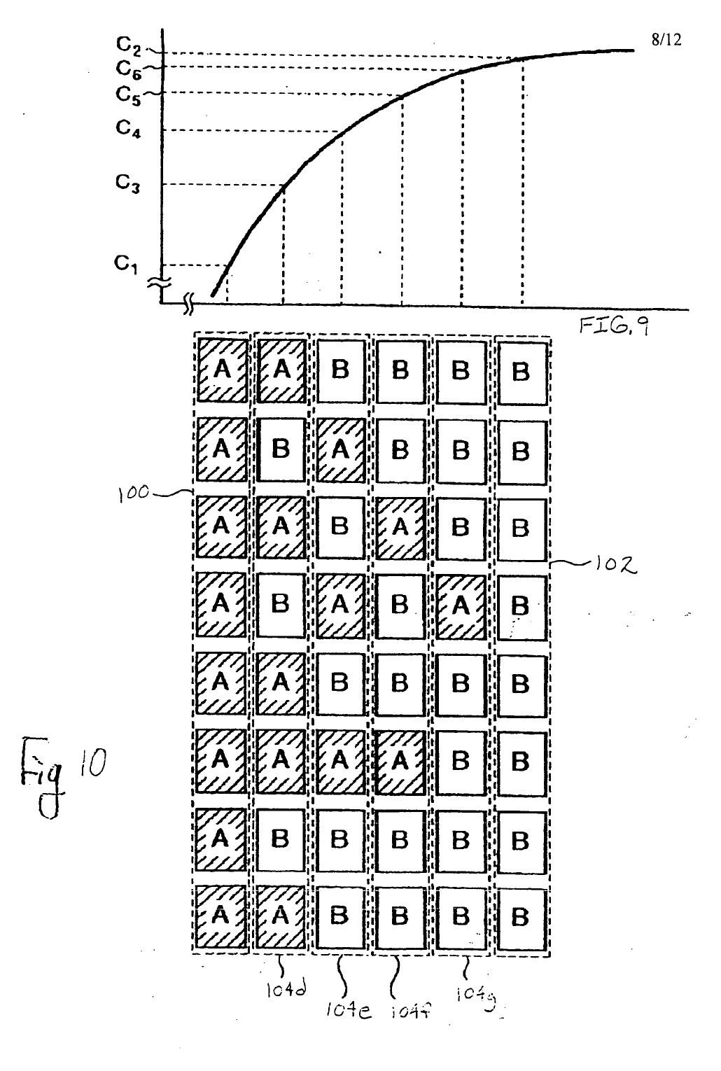

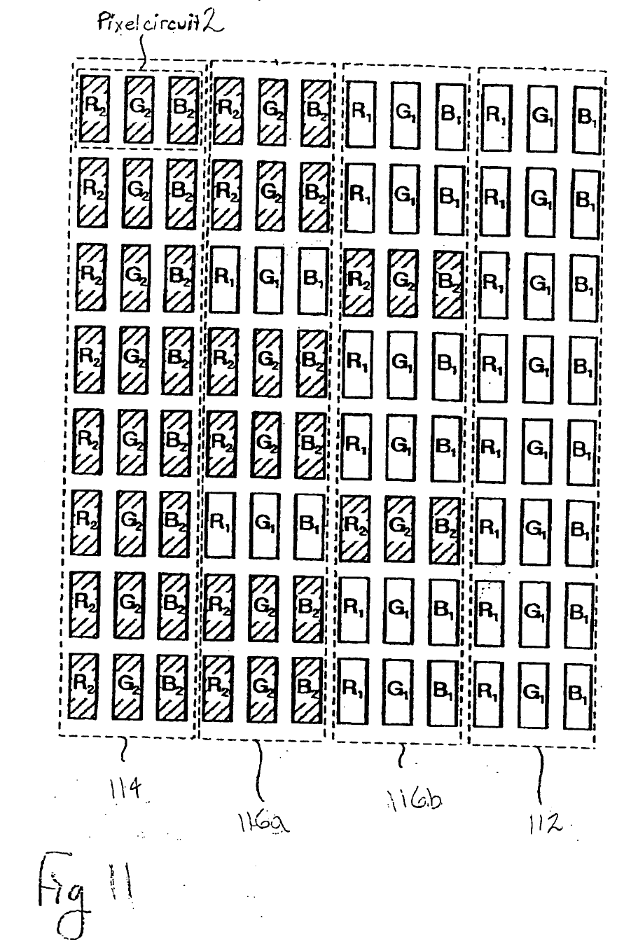

For example, as shown in FIG. 8, a repeating pattern of 16 pixels formed by 8 rows and 2 columns of mixed pixel circuits A and B may be reduced to a minimum number of mixed pixel circuits A and B arranged in a repeating pattern to improve resolution. Thus, the pattern formed by pixel circuits A and B as shown in 16 total pixel circuits 104b and 104c can be reduced from 8 rows to 4 rows because the mixed pixel pattern of pixel circuits A and B repeats every 4 rows. Thus, the number of pixels needed to achieve the desired capacitance C3 can be reduced from 16 pixels to 8 pixels, i.e. 4 rows by 2 columns. Another preferred embodiment of the present invention is shown in FIG. 10. FIG. 10 illustrates a structure that has a plurality of third circuit groups 104d, 104e, 104f, 104g disposed between the first pixel circuit group 100, and the second pixel circuit group 102. Each of the third pixel circuits 104d, 104e, 104f, 104g, respectively have a different internal capacitance Cgs. Each of the different internal capacitance Cgs are calculated by using a different weighting factor adjusted mean value determined from the ratio of pixel circuits A to pixel circuits B. Thus, the third pixel circuit groups 104d, 104e, 104f, 104g, have a ratio between the first pixel circuit A and the second circuit B that can be adjusted such that the weighing factor adjusted mean of the capacitance for each third pixel circuit groups equals capacitances C3-C6, respectively, as shown in the graph of FIG. 9 which is an enlarged view of FIG. 5. A high accuracy of forming capacitances C3-C6 for each Cgs in each pixel circuit group 116, 118, 120, and 122 is possible by having each pixel group be 8 rows in length and only one column wide.

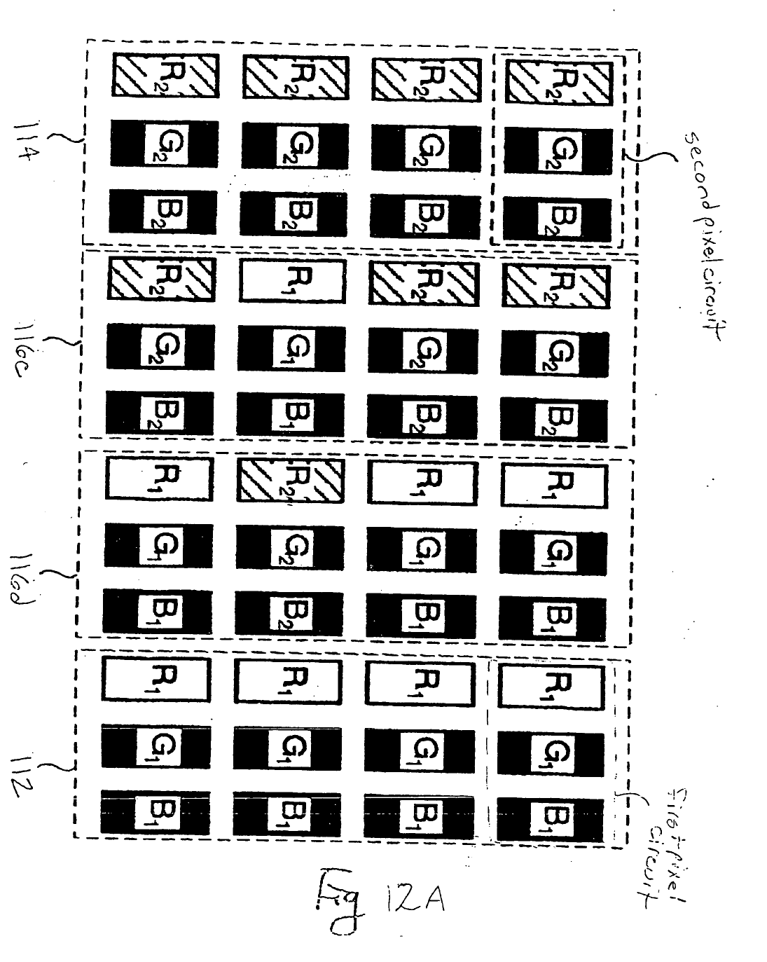

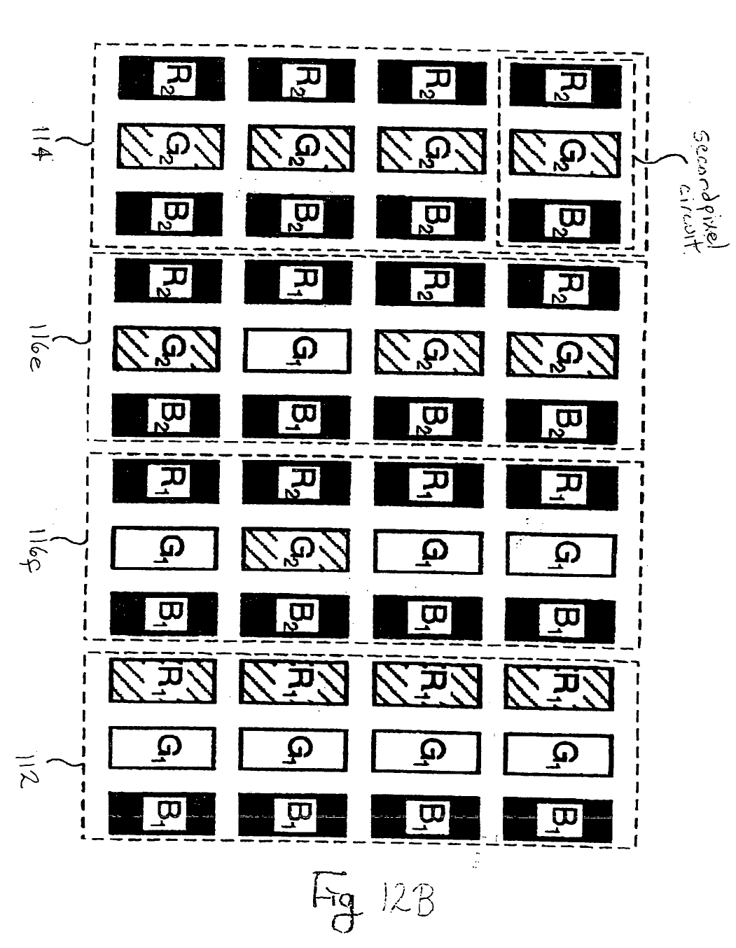

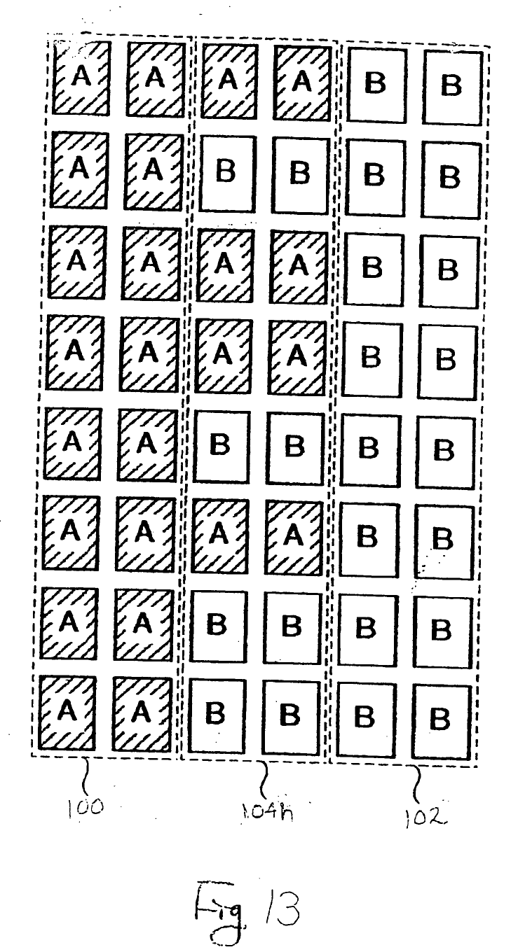

FIGS. 11, 12a, and 12b show an image display apparatus which has a structure for displaying color images by using adjacent R (red), G (green), and B (blue) sub-pixels. Individual pixels are formed by using a corresponding pixel circuit each having R,G,B sub-pixels. The third pixel circuit groups are formed by mixing pixel circuits that have different capacitances of the electrostatic capacitor Cgs. The same capacitance is used for forming a pixel circuit that has three sub-pixels, as shown as the second pixel circuit for the R,G, B sub-pixels in the upper left corner of each pixel matrix shown in FIGS. 11, 12a, and 12b.

FIG. 11 shows a preferred embodiment of the present invention wherein C1 is formed by the first pixel circuit including R1, G1 and B1 having a capacitance of the electrostatic capacitor Cgs installed on the matrix substrate 50 at a distance closer to scan line driver circuit 72b than a second pixel circuit, C2 is formed by the second pixel circuit including R2, G2, and B2 having a capacitance of the electrostatic capacitor Cgs, the first pixel circuit group 112 the second pixel circuit group 114 and the third pixel circuit group 116a, 116b for FIG. 11; 116c, 116d for FIG. 12A; and 116e, 116f for FIG. 12B.

The first pixel circuit including R1, G1, B1 and the second pixel circuit including R2, G2, B2 are each arranged to correspond to a Red, Green, and Blue sub-pixel. Each of the R, G, and B sub-pixels form color filters that are each provide a transmission window for a respective R, G, and B wavelength. For instance, they can be laid out on the surface of the opposing substrate 52 for corresponding to the sub-pixels, such that light transmitted through liquid crystal layer 54 passes through the color filters for displaying a color image. Moreover, by assembling adjacent R, G, B sub-pixels to each associated pixel circuit 66, a single first pixel circuit or second pixel circuit can be formed.

FIG. 12A displays a red color layer that makes the light of the wavelength corresponding to red pass through as an example. FIG. 12b displays a green color layer that makes the light of the wavelength corresponding to green pass through as an example.

As shown in FIG. 11, similar to the third pixel groups formed in FIGS. 7 and 13, the first pixel circuit group 112 and the second pixel circuit group 114, similar to the pixel circuit groups 100, and 102 in FIGS. 7 and 13, are formed by pixel circuits that have the same capacitance of the electrostatic capacitor Cgs. The third pixel circuit groups 116A, 116B as shown in FIG. 11, are pixel circuits formed by either the first pixel circuit including R1, G1, B1, or the second pixel circuit including R2, G2, and B2, by using both the first pixel circuit and the second pixel circuit in the formation.

The third pixel circuit group 116a, 116b is formed by mixing the first pixel circuit and the second pixel circuit together, wherein each of the first and second pixel circuits are formed either by sub-pixels R1, G1, B2, or by R2, G2, B2, respectively. In a color image display apparatus, not only a black/white image be displayed, the brightness of the sub-pixels corresponding to the R, G, B may also be adjusted for displaying a color image. Therefore, in a color image display apparatus, not only during a display of a black/white image and also during the display of a color image, the unevenness and brightness must be suppressed. When the color display is changed, the same suppression for the brightness non-uniformity of black/white images, is also required so that the images are uniformly displayed on the image display apparatus of the present invention.

FIGS. 12A and 12B, indicating color display, each have filters that allow only R FIG. 12A) or only G (FIG. 12B) to filter through as an image on an image display device of the present invention.

As shown in FIG. 12A wherein only R wavelength of light from each pixel is displayed as an image, the third pixel circuit group 116d indicates pixel circuits arranged in sequence ratio 2:1:1 from a top of the third pixel circuit group 116d as the first pixel circuit, the second pixel circuit, and the first pixel circuit. The third pixel circuit group 116c indicates pixel circuits arranged in sequence ratio 2:1:1 from a top of the third pixel circuit group 116d as the second pixel circuit, the first pixel circuit, and the second pixel circuit.

As shown in FIG. 12B, when only light having a green wavelength is displayed through a color filter as an image on the image display apparatus of the present invention, the pixel circuit used in the third pixel circuit group 116f, similar to the embodiment shown in FIG. 12A, is arranged in accordance with a ratio of 2:1:1 from a top of the pixel group 116f as follows: the first pixel circuit, the second pixel circuit, and the first pixel circuit. The third pixel circuit group 116e, is arranged in accordance with a ratio of 2:1:1 from a top of the pixel group 116f as follows: the second pixel circuit, the first pixel circuit, and the second pixel circuit.

When only B is displayed, or when white color is displayed that shows a complete R, G, and B spectrum, the distribution of the pixel circuits used in the display are the same. The present invention therefore provides an image display apparatus that does not enable non-uniform brightness even when changing the display color. If a white display is desired a high quality image of the apparatus can be displayed.

The present invention that operates to eliminate non-uniformities in pixel circuits caused by varying V_{feedthrough} and ≢Vₚᵢₓₑₗ is not limited to only LCD technology, but can be applied to other technologies that utilize light emitting or illumination devices to drive a display such as, but not limited to Plasma display panels, and organic liquid emitting diodes (OLED).

It should be understood that the invention is not limited to the exact embodiment or construction which has been illustrated and described but that various changes may be made without departing from the spirit and the scope of the invention.

1. An image display apparatus comprising:
a first pixel circuit group having a plurality of first pixel circuits each having a first capacitance;
a second pixel circuit group having a plurality of second pixel circuits each having a second capacitance; and
a third pixel circuit group having a plurality of both the first pixel circuits and the second pixel circuits arranged in accordance with a weighted average.

2. The image display apparatus of claim 1, further comprising:
an average third capacitance associated with the third pixel circuit group, wherein the third capacitance is greater than the first capacitance of each of the plurality of first pixel circuits, and wherein the third capacitance is less than the second capacitance of each of the plurality of second pixel circuits.

3. The image display apparatus of claim 2, wherein the third capacitance is formed in accordance with a weighted average of m number of first pixel circuits and n number of second pixel circuits, wherein m and n are positive integers.

4. The image display apparatus of claim 1, wherein said pixel circuits in each of the first and the second pixel circuits are formed by an associated pixel electrode for receiving a voltage corresponding to a display brightness and a signal line for transmitting a voltage signal.

5. The image display apparatus of claim 4, wherein the first capacitance is determined by the plurality of first pixel circuits and a wave form of a voltage signal transmitted by the signal line, and an electrostatic capacity formed between the associated pixel electrode and the signal line.

6. The image display apparatus of claim 5, wherein the second capacitance is determined by the plurality of second pixel circuits and a wave form of a voltage signal transmitted by the signal line, and an electrostatic capacity formed between the associated pixel electrode and the signal line.

7. The image display apparatus of claim 4, further comprising:
a switching component in each of the plurality of the first pixel circuits and in each of the plurality of the second pixel circuits for controlling a voltage supply to each of the associated pixel electrodes, and wherein the scan line performs a scan line function to operate a driving status of the switching component.

8. The image display apparatus of claim 1, further comprising:
a first substrate for forming each of the first, second and third pixel circuit groups;
a second substrate positioned opposite to the first substrate equipped with a common electrode for forming an electrostatic capacity among each of the pixel electrodes;
and a liquid crystal layer sealed in between the first substrate and the second substrate.

9. The image display apparatus of claim 1, wherein said third pixel circuit group is formed by m number of pixel circuits having the first capacitance from the first pixel circuit group, and is further formed by n number of pixel circuits having the second capacitance from the second pixel circuit group, and wherein m and n are positive integers.

10. The image display apparatus of claim 1, wherein each of the plurality of first pixel circuits associated with the first pixel circuit group each further comprise a plurality of red, green, and blue associated sub-pixels, wherein each of the associated red, green, and blue sub-pixels form color filters that each provide a transmission window for a respective red, green, and blue wavelength.

11. The image display apparatus of claim 1, wherein each of the plurality of second pixel circuits associated with the second pixel circuit group each further comprise a plurality of red, green, and blue associated sub-pixels, wherein each of the associated red, green, and blue sub-pixels form color filters that each provide a transmission window for a respective red, green, and blue wavelength.

12. The image display apparatus of claim 1, wherein each of the plurality of first and second pixel circuits associated with the first and second pixel circuit groups respectively and wherein each of the plurality of the first pixel circuits and the second pixel circuits arranged in accordance with a weighted average associated with the third pixel circuit group each further comprise a plurality of red, green, and blue associated sub-pixels, wherein each of the associated red, green, and blue sub-pixels form color filters that each provide a transmission window for a respective red, green, and blue wavelength.

13. An image display apparatus comprising:
a TFT matrix substrate having a first pixel circuit group associated with a first capacitance, a second pixel circuit group associated with a second capacitance, and a third pixel group associated with an average third capacitance, wherein the average third capacitance is formed from a plurality of first and second pixel circuits associated with the first and the second capacitances, respectively arranged in accordance with a weighted average; and
an opposing substrate which is positioned opposite to the TFT matrix substrate; and a liquid crystal layer which is sealed in-between the TFT matrix substrate and the opposing substrate.

14. The image display apparatus of claim 13, further comprising:
at least a first alignment film adhered to a top surface of the TFT matrix substrate;
at least a second alignment film adhered to a bottom surface of the opposing substrate, wherein the first and second alignment films operate to orient liquid crystal molecules disposed within the liquid crystal layer.

15. The image display apparatus of claim 13, wherein the matrix substrate and the opposing substrate have a structure formed with a transparent plastic substrate and quartz glass.

16. The image display apparatus of claim 13, wherein an outside surface of both the matrix substrate and the opposing substrate comprise a first and a second polarizer plate, respectively.

17. The image display apparatus of claim 13, further comprising:
a common electrode provided on an inside surface of the opposing substrate; and
a plurality of pixel electrodes each associated with first and second pixel circuits associated with each first and second pixel circuit groups.

18. The image display apparatus of claim 13, further comprising:
at least one color filter disposed on at least one of an inside surface of the opposing substrate or on an outside surface of the TFT matrix substrate that operates to display a color image.

19. The image display apparatus of claim 13, wherein each of the plurality of first and second pixel circuits associated with the first and the second capacitance comprise:
a switching component having a drain electrode, a source electrode and a gate electrode; and
a pixel electrode which receives a voltage signal that corresponds to a desired display brightness.

20. The image display apparatus of claim 19, wherein each of the plurality of first and second pixel circuits associated with the first and the second capacitance further comprise:
at least two associated scan lines that operate switch the switching component on and off;
at least two associated signal lines; and
a capacitance line that operates to maintain a fixed voltage to the pixel electrode.

21. The image display apparatus of claim 19, wherein the switching component is an n-channel thin-film transistor.

22. An method of forming an image display apparatus comprising the steps of:
providing a first pixel circuit group having a plurality of first pixel circuits each having a first capacitance;
providing a second pixel circuit group having a plurality of second pixel circuits each having a second capacitance; and
providing a third pixel circuit group formed by a plurality of the first pixel circuits and the second pixel circuits;
arranging the plurality of the first pixel circuits and the second pixel circuits used to form the third pixel circuit group in accordance with a weighted average.

23. The method of claim 22, further comprising:
providing an average third capacitance associated with the third pixel circuit group, wherein the average third capacitance is greater than the first capacitance of each of the plurality of first pixel circuits, and wherein the third capacitance is less than the second capacitance of each of the plurality of second pixel circuits.
